(19) United States
(12) Patent Application Publication
(10) Pub. No.: US 2022/0347754 A1
(43) Pub. Date: Nov. 3, 2022

(54) SYSTEM AND METHOD FOR CONTROLLED MANUFACTURING

(71) Applicants: COMMISSARIAT A L'ENERGIE ATOMIQUE ET AUX ENERGIES ALTERNATIVES, Paris (FR); V.L.M. SARL, Lacanau De Mios (FR); BEAM, Strasbourg (FR)

(72) Inventors: JEAN-DANIEL PENOT, Suresnes (FR); JEROME LAURENT, Paris (FR); CELIA MILLON, Orsay (FR); PHILIPPE VERLET, La Teste de Buch (FR); JONATHAN FRECHARD, Illkirch - Graffenstaden (FR)

(21) Appl. No.: 17/621,072

(22) PCT Filed: May 25, 2020
(86) PCT No.: PCT/FR2020/050864

§ 371 Date: Dec. 20, 2021

(30) Foreign Application Priority Data
Jun. 20, 2019 (FR) FR1906669

(51) Int. Cl. B22F 10/85; B33Y 10/00; B33Y 30/00; B33Y 50/02; B22F 12/41; B22F 12/90; B22F 10/28; B22F 10/22; B23K 26/03

(52) U.S. Cl. CPC B22F 10/85; B33Y 10/00; B33Y 30/00; B33Y 50/02; B22F 12/41; B22F 12/90; B22F 10/28; B22F 10/22; B23K 26/034; B23K 26/342

(57) ABSTRACT

Controlled manufacturing system suitable for controlling a method for manufacturing, repairing or resurfacing a part by deposition of material under concentrated energy, said controlled manufacturing system comprising:
means for obtaining a three-dimensional digital model of the part;
means for generating a manufacturing file for the part, based on the three-dimensional digital model of said part, to define manufacturing parameters of an additive manufacturing machine, said manufacturing parameters being associated with manufacturing instructions;
means for generating a control file for the part to define control parameters of a control effector, said control parameters being associated with control instructions;
analysis means for carrying out an analysis of the manufacturing file and the control file in order to determine if the manufacturing parameters and the control parameters can coexist during the simultaneous application of the manufacturing parameters to the additive manufacturing machine and the control parameters to the control effector;
a control module comprising at least one communication channel for receiving and sending the manufacturing instructions to a polyarticulated manufacturing system suitable for supporting the additive manufacturing machine, and at least one communication channel for receiving and sending the control instructions to a polyarticulated control system suited to supporting the control effector, to manage simultaneously the additive manufacturing machine and the control effector.

### FIELD OF THE INVENTION

The present invention relates to the field of additive manufacturing, more specifically the category of methods for directed energy deposition (DED) and even more specifically a system and a method for controlled manufacture concerning a part to manufacture, to repair or to resurface by means of a DED additive manufacturing method.

### PRIOR ART

Additive manufacturing designates a set of methods for manufacturing by addition of material. The methods for projecting material or depositing material (DED) are defined by an addition of material—notably in powder, wire or filament form—at the level of the manufacturing zone. The activation sources may be diverse, generally a laser, an electron beam or an electric arc, but other forms of energy may be envisaged such as, without these being limiting, a plasma source or a combination of the preceding sources.

Nowadays, the control of parts produced by additive manufacturing is carried out after the manufacture of said parts and/or by methods for controlling the manufacturing method.

Thus, non-destructive control methods and destructive control methods exist.

Non-destructive control methods notably comprise radiography, tomography, conventional ultrasounds, Foucault currents, thermography, shearography. Destructive control methods notably comprise mechanical tests and are carried out on finished parts. These methods thus do not enable the detection of defects during the manufacture of the parts. Furthermore, these methods do not make it possible to put in place a feedback loop to stop manufacture or to modify certain parameters as soon as a defect is detected. Finally, these destructive control methods are not efficient when the parts concerned have complex final geometry.

Control methods during manufacture also exist, such as control of the hot melt, control by camera in the visible or in the infrared. However, these methods only enable local control, surface control or even superficial control below the surface. This type of method does not guarantee the integrity of the part when said part contains buried defects that have appeared during the manufacturing method or when the defect, for example a fissure, appears far from of the manufacturing nozzle.

The implementation of control methods within DED additive manufacturing methods is described in the prior art. One of these methods is a control method by laser ultrasounds.

The control method by laser ultrasounds is based on a control device constituted of a generation laser and a detection laser. The emission of a laser beam from the pulsed generation laser on the part to control brings about the propagation of elastic waves, by photothermal effect (in thermoelastic regime) or ablation. The ultrasound waves propagate into the part to control. In the presence of a defect, the multichannel digital control director interacts with said defect. Thus, these mechanical waves are in part reflected or diffracted and are attenuated while producing a signature at the level of the detection point. The detection laser coupled to an optical interferometer makes it possible to measure the displacement normal or tangential to the surface of the part to control.

The prior art contains various works concerning the use of ultrasounds for control during additive manufacturing; including very rare embodiments during manufacturing.

In the majority of these studies exclusively conducted in the laboratory, the two control lasers are fixed, which makes the inspection of a part during manufacture impossible or at least extremely limited in terms of geometry. Thus, the inspection only concerns the zone of the part positioned facing the lasers. They are thus parts with very simple geometry. The tests carried out in Palermo and disclosed in document [1] are distinguished by the control lasers being made integral with the kinematic assembly of the manufacturing nozzle. This device enables control of the upper bead only in particular conditions: on the one hand, the control is limited to nozzle movements that are sufficiently slow to enable acquisition and on the other hand the control is limited to very simple geometries and trajectories, without marked curvature. Next, possible movements of the part with respect to the frame of reference of the machine structure are restricted or even impossible, without which the control lasers are no longer orthogonal with respect to the zone to control. Furthermore, the high temperature of the controlled zone that has just been melted affects the ultrasound propagation, and consequently complicates the analysis of the signal and the detection of defects. In order to overcome these defects, one technical solution is the use of industrial robotics to carry the sensor.

Traditionally, industrial robotics employ control racks for managing a large number of axes, but the number of axes is rapidly limited, typically to from 6 to 8 axes per rack. For a greater number of directions of movement, several racks are synchronised with each other. These racks may optionally be supervised by a digital control. This induces communication delays and problems of translation of languages between the digital control and the racks. Real time synchronisation for rapid phenomena may be limited. Further, the use of racks generally prohibits access to motor controller variables (duration and acceleration speed, deceleration, etc.) which can be useful for improving the stability of movements, such as for example the onset of jerks. Thus, the hybrid management of manufacture and real time control can only be realised in a degraded manner by the use of racks. In addition, the use of several racks suggests that the trajectory of each mechanical system will be programmed independently, communication between the racks being limited.

In addition, polyarticulated robots are mainly used to perform pick and place, that is to say the action of taking an object from a point A to take it to a point B as quickly as possible. The constraints on what happens between A and B are very limited. Control racks have been designed with this aim. To control the part in situ, the robot needs to perform a precise trajectory at a given speed.

An alternative to the use of control racks is to use a digital control director (DCD), that is to say a device that digitally controls the displacements of different moveable members while interpreting the instructions to act on an actuator. A multichannel DCD has several outputs, commonly used to manage two independent actions. Machine tools with digital control provide a characteristic example. Traditionally, systems using a multichannel digital control director use this approach to perform two steps. For example, a typical use of the multichannel digital control director concerns twin turret lathes where two tools machine a rotating part. Each tool has its machining programme and no communication exists between the two tools. Only programme pauses for a tool while waiting for the other tool to perform an operation exist.

The present invention proposes a system and a method making it possible to take into account geometric complexities and trajectory complexities of parts during manufacture, in order to enable an inspection by laser ultrasounds during their industrial manufacture.

### Subject Matter of the Invention

The subject matter of the present invention relates to a controlled manufacturing system suitable for controlling a method for manufacturing, repairing or resurfacing a part by deposition of material under concentrated energy, said controlled manufacturing system comprising:
means for obtaining a three-dimensional digital model of the part;
means for generating a manufacturing file for the part, based on the three-dimensional digital model of said part, to define manufacturing parameters of an additive manufacturing machine, said manufacturing parameters being associated with manufacturing instructions;
means for generating a control file for the part to define control parameters of a control effector, said control parameters being associated with control instructions;
analysis means for carrying out an analysis of the manufacturing file and the control file in order to determine if the manufacturing parameters and the control parameters can coexist during the simultaneous application of the manufacturing parameters to the additive manufacturing machine and the control parameters to the control effector;
a control module comprising at least one communication channel for receiving and sending the manufacturing instructions to a polyarticulated manufacturing system suited to supporting the additive manufacturing machine, and at least one communication channel for receiving and sending the control instructions to a polyarticulated control system suited to supporting the control effector, to manage simultaneously the additive manufacturing machine and the control effector.

In a preferred manner, the controlled manufacturing system comprises a generation laser capable of emitting an initial generation laser beam and a detection laser capable of emitting an initial detection laser beam to carry out a control on the part according to a laser ultrasound method.

In a preferred manner, the control effector comprises a device for shaping the initial generation laser beam for producing a generation laser beam and a device for shaping the initial detection laser beam for producing a detection laser beam.

In a preferred manner, the control effector comprises a device for adjusting the inter-laser distance to fix the distance between the generation laser beam and the detection laser beam.

In a preferred manner, the control module is a multichannel digital control director.

In a preferred manner, the control effector comprises a contactless temperature measurement probe in the vicinity of the control zone of the part.

In a preferred manner, the control effector is combined with one or more other control means, optionally borne by the control effector for detecting or even locating defects of the part within the additive manufacturing machine.

According to a second aspect of the present invention, the invention relates to a method for controlled manufacture suitable for a method for manufacturing, repairing or resurfacing a part, by deposition of material under concentrated energy, comprising the following steps:
generation of a three-dimensional digital model of the part to manufacture, repair or resurface, for modelling said part;
generation of a manufacturing file for the part, based on the three-dimensional digital model of the part, to define manufacturing parameters of an additive manufacturing machine, said manufacturing parameters being associated with manufacturing instructions;
generation of a control file to define control parameters of a control device, said control parameters being associated with control instructions;
analysis of the manufacturing file with the control file in order to determine if the manufacturing parameters and the control parameters can coexist during the simultaneous application of the manufacturing parameters to the additive manufacturing machine and the control parameters to the control effector;
if the manufacturing parameters and the control parameters can coexist, simultaneously managing the additive manufacturing machine and the control effector for manufacturing, repairing or resurfacing the part, said simultaneous management being based on the manufacturing instructions and the control instructions.

In a preferred manner, the method for controlled manufacture, comprises the following step:
if the manufacturing parameters and the control parameters cannot coexist:
generation of a manufacturing file for the part, based on the three-dimensional digital model of the part, to define manufacturing parameters of an additive manufacturing machine, said manufacturing parameters being associated with manufacturing instructions; and/or
generation of a control file to define control parameters of the control effector, said control parameters being associated with control instructions.

In a preferred manner, the method for manufacturing, repairing, or resurfacing the part by deposition of material under concentrated energy is a method for melting metal powder by laser, or melting metal wire by laser or melting metal wire by electric arc.

In a preferred manner, the control instructions target the regions of the part having increased probabilities of appearance of defects.

In a preferred manner, a detection of defects leads to stoppage of manufacture.

In a preferred manner, a detection of defects leads to the carrying out of a corrective action such as the melting or the machining of the defective zone of the part.

### BRIEF DESCRIPTION OF THE DRAWINGS

The aims, subject matter and characteristics of the present invention will become clearer on reading the description that follows, made with reference to the figures, in which:

FIG. 1 shows a controlled manufacturing system according to an embodiment of the invention,

FIG. 2 shows a diagram of the arrangement of the generation and detection laser beams during the control of a part to manufacture, to repair or to resurface.

FIG. 3 shows a diagram of a part comprising a bend and the arrangement of the generation and detection laser beams before the bend,

FIG. 4 shows a diagram of a part comprising a bend and the arrangement of the generation and detection laser beams after the bend,

FIG. 5 shows a diagram of operation of a method for controlled manufacture according to the invention,

FIG. 6 represents the system according to the invention according to a top view to illustrate the first step of a method for controlled manufacture of a part to manufacture, repair or resurface,

FIG. 7 represents the system according to the invention according to a top view to illustrate the second step of a method for controlled manufacture of a part to manufacture, repair or resurface,

FIG. 8 represents the system according to the invention according to a top view to illustrate the third step of a method for controlled manufacture of a part to manufacture, repair or resurface,

FIG. 9 represents the system according to the invention according to a top view to illustrate the fourth step of a method for controlled manufacture of a part to manufacture, repair or resurface.

FIG. 1 shows a controlled manufacturing system 100 according to the invention.

### SYSTEM FOR CONTROLLED MANUFACTURE

### Polyarticulated Manufacturing System and Manufacturing Machine

The controlled manufacturing system 100 comprises at least one polyarticulated manufacturing system 138 in the field of additive manufacturing by projection or deposition of material. The polyarticulated manufacturing system 138 is one of the components of an additive manufacturing machine, said machine also comprising a part holder tray, an energy source such as a continuous laser, an electron source or an electric arc and a system for supplying raw material in controlled quantity per time unit. The raw material is generally in the form of powder or metal wire. Typically, in the case of deposition of powder, the polyarticulated manufacturing system 138 is composed on the one hand of a sub-system moving the manufacturing nozzle, for example a x-y-z (3 axes) cartesian translation system enabling the displacement of the manufacturing nozzle, and on the other hand a sub-system moving the part holder tray for example along two axes of rotation. The manufacturing nozzle groups together the powder and energy inputs.

### Control System and Control Effector

The controlled manufacturing system 100 comprises at least one control system 102. The control system 102 comprises a generation laser 114, a detection laser 120, a device for shaping 118 the initial generation laser beam 116 coming from the generation laser 114, a device for shaping 124 the initial detection laser beam 122 coming from the detection laser 120, a device for adjusting the inter-laser distance (DADI) 128, an interferometer 126 described in detail below. The shaping devices 118, 124 and the DADI 128 are grouped together with an optical head or control effector 130 detailed hereafter.

The control system 102 also comprises a polyarticulated control system 132 suitable for supporting the control effector 130. Optionally, one or more polyarticulated control systems 132 may comprise one or more control effectors 130 of different nature such as a camera in the visible or a camera in the infrared and/or several effectors for locally treating the part during manufacture such as machining, surface treatment or thermal treatment effectors.

In a preferred manner, the generation laser 114 comprises a pulse laser of pulse duration of the order of a nanosecond and of which the wavelength is chosen to be absorbed by the material to control. Thus, for metals, the laser chosen is preferentially a 1064 nm or 532 nm YAG laser. The generation laser 114 emits an initial generation laser beam 116 conveyed by optic fibre to the control effector 130 where the generation laser beam 116 is shaped by the shaping device 118, before the shaped laser beam 134 is emitted in the direction of a part 140 to manufacture, to resurface or to construct.

The control effector 130 thus comprises a device for optically shaping 118 the generation laser beam 116 placed between the output of the generation laser 114 and the part 140 to control. This optical shaping device 118 is designed to shape the initial generation laser beam 116 in order to obtain a shaped laser beam 134 and impacting the part according to a disc of diameter comprised between 0.2 and 5 mm or a source line of 0.2 mm width and 2 to 10 mm length. Thus, one obtains a wider passband and a direction of propagation of the ultrasounds orthogonal to the source line, which has the effect of optimising the generation of a Rayleigh wave, thus favouring the detection of defects of DED additive manufacturing (f>10 MHz, i.e. □<0.2 mm). This optical shaping device 118 is composed of an assembly of optical lenses.

The output of the optical device for shaping 118 the generation laser beam 116 is positioned via the polyarticulated control system 132, at a distance from the surface of the part 140 to control comprised between 1 mm and 1 m, and if appropriate at a maximum distance enabling the incorporation of the control effector 130 and the polyarticulated control system 132 within the manufacturing enclosure (not shown) when it exists, of the additive manufacturing machine, preferably between 5 mm and 300 mm.

The control system 102 comprises a detection laser 120, preferentially a long pulse or continuous type laser. The initial detection laser beam 122 is shaped by the optical shaping device 124 to form a shaped detection laser beam 136. The reflection of this detection laser beam 136 on the wall of the part 140 is measured by the interferometer 126.

The control system 102 also comprises the interferometer 126 such as an interferometer of the confocal Fabry-Perot type, mixture with two waves employing a photorefractive AsGa crystal, homodyne with multi-detector technology, or infrared (1550 nm) Doppler effect vibrometers. The interferometer is coupled to the detection laser 120. Preferentially, the interferometer 126 belonging to the control system 102 is not carried on board the polyarticulated control system 132. Optionally, but in a non-preferential manner, if the stability of its constituent optical elements is ensured, the interferometer 126 may be included in the control effector 130.

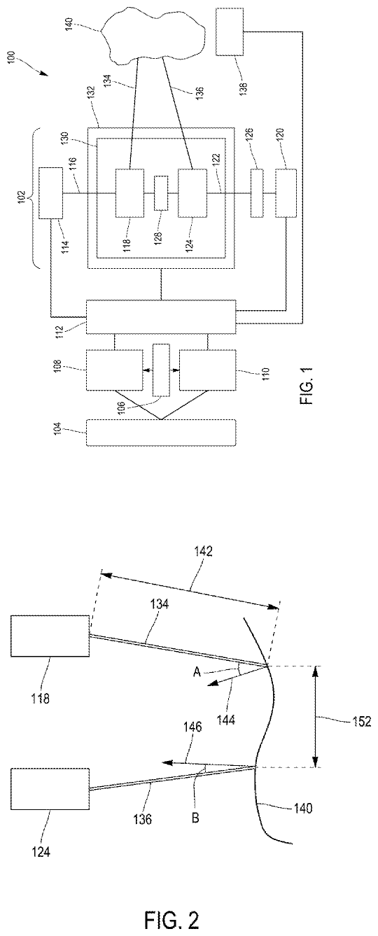

As shown in FIG. 2, the generation 134 and detection 136 laser beams are inclined with respect to the normal of the surface of the part.

The generation laser beam 134 is inclined by an angle A from 80 degrees (°) to 0° with respect to the normal 144 of the surface of the part at the generation point, and more preferentially from 50° to 0°, and even more preferentially 0°, that is to say normal to the surface of the part 140 at the impact point.

The detection laser beam 136 is inclined by an angle B of 0° to 60° with respect to the normal 146 of the surface of the part at the detection point. The angle of collection B will preferentially be chosen to dissociate the measurement of the displacement in plane (uz) or out of plane (uz), i.e. normal or parallel to the surface of the part, and respectively at the epicentre or out of the epicentre. Spot laser symmetry imposes zero parallel displacement at the epicentre. For the measurement of the normal displacement, the angle B will preferentially be chosen between 0° and 5°, and more preferentially 0°, that is to say normal to the surface of the part. For the measurement of the transversal displacement, the angle of collection B will preferentially be taken between 5° and 60°. From the sensitivity viewpoint, the optimum angle depends on the surface diffusion properties. The diffusion intensity decreases slightly up to angles of the order of 45° and the signal to noise ratio depends on sine B. The angle of collection is advantageously chosen for B>10°. An angle of incidence B, comprised between 30° and 45°, will preferentially be chosen from the viewpoint of dephasing, sensitivity and precision. The uz/ux amplitude ratio depends directly on the angle of collection B and the Poisson coefficient of the material. The choice of the angle B also takes account of the type and performances of the interferometer used (Mach-Zehnder, confocal Fabry-Perot, Doppler vibrometer) or interferometer for mixing two waves using a photo-refractive crystal and an optic with large aperture (collection of the backscattered light by the inspected surface for different incident angles).

The control effector 130 preferentially comprises a device for adjusting the inter-laser distance (DADI) 128 shown in FIG. 1 which makes it possible to vary the spacing or the distance represented by the double arrow 152 shown in FIG. 2 between the generation laser beam 134 and the detection laser beam 136. At the level of the surface of the part 140, this distance is comprised between 0 mm, that is to say that the generation 134 and detection 136 laser beams are merged, and 150 mm, preferentially between 5 mm and 100 mm. The DADI 128 makes it possible to move away or bring closer the generation 134 and detection 136 laser beams during the control.

In FIG. 2, the distance of the device for shaping 118 the generation laser beam to the part 140 is represented by the double arrow 142.

The distance separating the generation 134 and detection 136 laser beams may thus be managed by the multichannel digital control director described below in order to adapt to the geometry of the part 140 and to the movements induced by the manufacture of said part 140.

The adjustment of the distance between the generation 134 and detection 136 laser beams is provided according to two embodiments.

In a first so-called “off-line” embodiment, that is to say outside of the manufacturing method, the adjustment takes place as of the generation of the control file, described hereafter, for the part 140. Indeed, for each control point on the part, the control design software 110 described below calculates the curvature of the part 140 and deduces therefrom the optimal inter-laser distance. The software 110 can then write in the control file, for each control point, the distance between the generation 134 and detection 136 laser beams. The digital control 112 will manage the device DADI 128 as a function of the value given for the forthcoming control point.

In a second so-called “on-line” embodiment, that is to say during the manufacturing method, the adjustment takes place by means of a digital control. A digital control is going to give movement instructions to the motors as a function of the supplied programme. The digital control reads the programme and transforms the instructions into set points on the motors and other elements such as lasers. The digital control reads the control file in advance and for each control point, it thus knows the next control point. If the control points are close to each other and if the variation in the curvature is moderate, then the digital control adapts the distance between the generation laser beam 134 and the detection laser beam 136 by means of the DADI 128 without intervention of the user.

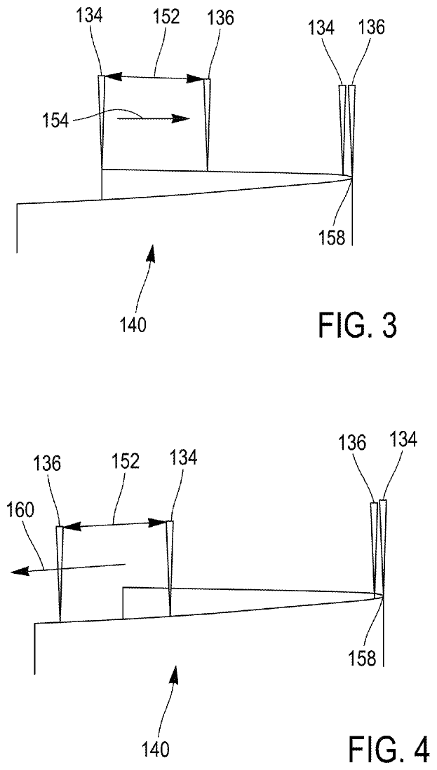

In the presence of a bend 158, shown in FIG. 3, on the surface of the part 140, the management of the control trajectory takes place in two stages.

FIG. 3 shows the management of the control trajectory according to the direction of displacement shown by the arrow 154. Before the bend 158, the determined or nominal distance 152 between the generation laser beam 134 and the detection laser beam 136 decreases in an incremental manner until the two generation 134 and detection 136 beams are superimposed.

FIG. 4 shows the management of the control trajectory according to the direction of displacement shown by the arrow 160. After the bend 158, the distance between the generation laser beam 134 and the detection laser beam 136 increases until the two generation 134 and detection 136 beams are separated by the determined distance 152. This embodiment makes it possible to ensure the control in the presence of a bend. Indeed, if the distance 152 is maintained while the control effector 130 is close to the bend, the detection laser 136 will be outside of the part 140.

The control effector 130 may also comprise a contactless temperature measurement probe (not shown) in the vicinity of the control zone 174 of the part 140. This temperature measurement probe is used for a more precise processing of the ultrasound propagation measurements. Preferentially, a calibration of the behaviour, that is to say of the speed of propagation of the ultrasounds as a function of temperature, may be carried out beforehand. The temperature measurement probe may for example be a measurement by infrared thermometry.

The control effector 130 also comprises a protective housing which makes it possible to contain the shaping devices 118, 124, the DADI 128, the temperature measurement probe (not shown) and optionally the interferometry device 126.

In a preferred manner, the protective housing of the control effector 130 is pressurised in order to avoid the deposition of dust on optical elements such as lenses. More preferentially, the presence of a gaseous flow outside of the protective housing prevents any pollution of optical elements by dust, smoke or projections of material linked to the additive manufacturing method. In addition, the output orifice of the lasers 134 and 136 of the effector 130 is protected by a window that is transparent to the wavelength of the lasers used. The control housing of the control effector 130 is fixed to the polyarticulated control system 132.

In a preferred manner, the generation 114 and detection 120 lasers are not included in the protective housing of the control effector 130 and not integral with the polyarticulated control system 132. Preferably, the generation 114 and detection 120 lasers are shifted outside of the manufacturing chamber of the additive manufacturing machine when it exists, the initial generation 116 and detection 122 laser beams being conveyed by optic fibre to the shaping devices 118, 124.

### Computer Aided Design/Computer Aided Drafting Software

The controlled manufacturing system 100 also comprises means for obtaining 104 a three-dimensional digital model of the part 140. For example, the controlled manufacturing system 100 comprises computer aided drafting or computer aided design software making it possible to generate a file, for example an STP file relative to a three dimensional digital model of the part 11 to manufacture, repair or resurface. This file defines the geometry of the part, that is to say the entire volume of the part or simply its surfaces. This file may also come from another software. This file is intended to be transmitted to the computer aided manufacture software 108 and to the design software of the control 110 described below.

### Computer Aided Manufacture Software

The controlled manufacturing system 100 comprises means for generating 108 a manufacturing file for the part to manufacture, repair or resurface. For example, the control system comprises computer aided manufacture software 108 making it possible to generate a manufacturing file defining the parameters necessary for manufacture by the additive manufacturing machine. These manufacturing parameters comprise the displacements of the head or manufacturing nozzle carried by the sub-polyarticulated manufacturing system 138 over time and along for example three axes or degrees of freedom, or at the most along six axes. These manufacturing parameters also comprise the displacements over time of the kinematic assembly, that is to say the part holder tray and the part 140, generally along two axes. Finally, the manufacturing parameters comprise printing parameters such as the power of the energy source, the type and the properties of the manufacturing head, the flow rate of material, the gaseous atmosphere.

### Design Software of the Control

The controlled manufacturing system 100 comprises means for generating a control file. For example, the controlled manufacturing system 100 comprises design software for the control 110 generating a control file containing control parameters. These control parameters comprise the definition of the relative positions at the control zones of the part 140, said zones being defined by the two generation 134 and detection 136 laser beam impact points and the instants and the durations of control. These control parameters also comprise the position of the polyarticulated control system over time and the distance 152 between the two beams. Optionally, these control parameters comprise the orientation of the generation 134 and detection 136 laser beams. Finally, the control parameters comprise the parameters for implementing the generation 114 and detection 120 lasers such as the power, the rate of shots and the number of shots.

### Analysis Means

Thus, the controlled manufacturing system 100 also comprises analysis means 106 to carry out a comparative analysis of the manufacturing files and control files in order to determine if the manufacturing parameters and the control parameters can coexist, that is to say whether they are compatible.

The definition or the generation of the manufacturing file and the control file may be done in a distinct manner, that is to say on different digital tools. However, these manufacturing and control files should be produced jointly.

Indeed, the definition of the control parameters must take into account the manufacturing parameters. For example, the programming of a control of a control zone of the part 140 must take account of the displacement of the part during manufacture, said displacement being defined as a manufacturing parameter.

In addition, the definition of the manufacturing parameters must be done to enable the control of the part 140, that is to say that the movements of the elements of the polyarticulated manufacturing system 138 must enable the integration of the polyarticulated control system 132 in the vicinity of the manufacturing zone, without bumping into or damaging either the polyarticulated control system 132 or the part 140 under construction.

In a preferred manner, the definition of the manufacturing parameters must be carried out to favour said control of the part 140 that is to say that the solution which facilitates the control is selected in order for example to limit the movements of the polyarticulated control system 132.

This conciliation of control and manufacture may be done by the user or digitally by means of simulation tools, such as for example trajectory simulation software, or even of a digital twin of the system including or not a simulation of ultrasound propagation.

### Multichannel Digital Control Director

The controlled manufacturing system 100 comprises a control module or multichannel digital control director (DCD) 112 which manages in a coupled manner at least one polyarticulated control system 132 described above, and at least one polyarticulated additive manufacturing system 138 described above and does so as a function of the parameters of the manufacturing files and the parameters of the control files. The multichannel control director 112 may be a digital control in multichannel mode. The multichannel control director 112 uses at least two distinct channels comprising at least one channel for sending the manufacturing instructions to the polyarticulated manufacturing system and at least one channel for sending the control instructions to the polyarticulated control system. The technical effect of this characteristic is to resolve the problem of managing the synchronisation of a plurality of axes or degrees of freedom. Thus, the multichannel control director 112 according to the invention can manage in a synchronised manner and simultaneously a plurality of axes for the polyarticulated manufacturing system 138—greater than or equal to three, typically five-and a plurality of axes for the polyarticulated control system 132, typically seven.

The movements of the axes of the polyarticulated control system(s) 132 are synchronised with those of the axes of the polyarticulated manufacturing system 138, thus enabling a control adapted to the trajectory and to the orientation of the part during the manufacturing method.

Optionally, a digital system, called digital twin of the system, may make it possible to ensure the feasibility of the calculated movements, notably by avoiding any collisions and by guaranteeing an efficient management of the control points.

The multichannel digital control director 112 also controls the generation 114 and detection 120 lasers to cause the emission of the initial generation 116 and detection 122 laser beams by means of triggering signals.

### METHOD FOR CONTROLLED MANUFACTURE

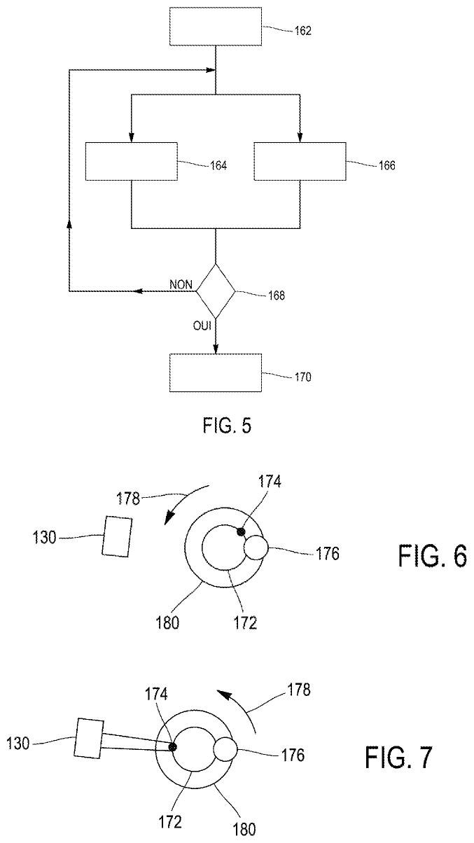

The controlled manufacturing system operates according to a method for controlled manufacture which comprises the following steps shown in FIG. 5.

In a step 162, the computer aided drawing or computer aided design software 104 generates a three dimensional digital model of the part 140 to manufacture, repair or resurface in order to model the part 140 to manufacture by means of the additive manufacturing machine (not shown).

In a step 164, the computer aided manufacture software 108 generates a manufacturing file for the part 140 to manufacture in order to define the manufacturing parameters.

In a step 166, the design software of the control 110 generates a control file in order to define the control parameters.

Steps 164 and 166 are carried out simultaneously and by successive iterations between step 164 and step 166 to define a control programme within a control file compatible with the manufacturing programme within a manufacturing file, and vice versa.

In a step 168, the manufacturing and control files are analysed by means of analysis means 106 such as a user or an analysis module in order that the control parameters take into consideration the manufacturing parameters and in order that the manufacturing parameters enable or even favour the control. This step 168 makes it possible to verify that the control parameters do not interfere with the manufacturing parameters. In other words, step 168 makes it possible to verify that the control parameters can coexist with the manufacturing parameters. If the control and manufacturing programmes are not compatible, then the method for controlled manufacture recommences after step 162.

In a step 170, the multichannel digital control director 112 manages simultaneously the polyarticulated control system 132 and the polyarticulated manufacturing system 138 on the basis of the manufacturing instructions and the control instructions.

### CONTROL STRATEGIES

The control described by the present invention is carried out in a machine or an additive manufacturing installation by projection or deposition of material. As explained above, said control is preferentially carried out during manufacture, i.e. simultaneously with the deposition or with the projection of material. Said control may also be carried out before manufacture—for example in the case of a repair or an addition of a function—or after manufacture.

Control by the laser ultrasounds method aims to detect anomalies or defects of the part within the additive manufacturing machine. The targeted anomalies are mainly: thickness variations, localised defect(s) such as a porosity or an inclusion, extended defects such as a fissure, and/or variations in the structure of the material (density loss, microstructural anisotropy, modification of the elastic properties of the material). Information on the roughness may also be obtained. The characteristic dimension of volume defects detected individually must be greater than 50 μm, preferentially greater than 100 μm, even more preferentially greater than 300 μm.

The generation of ultrasounds may only be done on the faces of the part accessible to the generation laser. The detection of ultrasounds may only be done on the faces of the part accessible to the detection laser. Between the two laser impact points, ultrasound propagation makes it possible to probe in the volume and on the surface the control zone situated between the two lasers.

The control zones may cover the entire part, be random, or, preferentially, target regions of interest (ROI)—that is to say regions having increased probabilities of appearance of defects—such as:
stress concentration zones, known to those skilled in the art or determined by thermomechanical analysis, notably by simulation by finite elements;
bead coverage zones, notably the interfaces between contour and filling beads;
geometric singularities such as the zones above which the nozzle has made a sudden variation in trajectory.

The control by the laser ultrasounds method may be combined with another means of controlling the part being manufactured or the manufacturing method such as for example:
cameras in the visible or infrared domain making it possible to detect presumed geometric variations, the suspicion of defect, or thermals of the part;
a coaxial inspection of the molten zone giving access to instabilities of this molten zone being able to generate defects;
sensors probing the manufacturing enclosure, such as for example thermocouples or gas detectors;
machine data able to indicate drifts from the manufacturing method such as the laser power, the displacement of motors, the flow rate of powder, the analysis of the radiation induced by the plasma.

This combination of one or more of the control means makes it possible to identify opportune control zones. Further, in the event of uncertain indication, this combination of control means makes it possible to ensure the presence of a prohibitive defect, i.e. above the specification and requirement thresholds. Statistical learning or artificial intelligence approaches, notably of machine learning type, may make it possible to refine the anomaly acceptance criteria, including by combining the data of several control means, of which laser ultrasounds.

The choice of the control strategy, defined according to the criticality of the part and the acceptable defects, is made during step 166 and validated during step 168. Even in the case of identification of control zones during the method, by the detection of an average control indication or additional surveillance, the principle remains the same: the possible control zones have been referenced during step 166, validated at step 168, only the triggering of the control is conditioned on the detection of a suspicion of defect.

### SANCTION

When a defect is detected by the controlled manufacturing system 100 during an “on-line” control, that is to say in the course of the manufacturing method, two action levels (not represented in the figures) are possible.

Within the first action level, the diagnosis of the presence of a defect is confirmed. An automatic or manual (by the user) control then stops the manufacture of the part. This action makes it possible to limit losses due to remaining machine times and the quantity of raw material required to produce the remainder of the non-compliant part.

Within the second level, preferentially under the action of a user and as a function of the nature of the defect, the defective zone may be remelted by the action of the single laser beam of the manufacturing machine or by the combined action of the laser beam and the powder of the manufacturing machine if a lack of material exists. The incriminated zone may also be machined to carry out once again manufacture on a healthy zone.

### EXAMPLES

An exemplary embodiment is illustrated by FIGS. 6 to 9 which show the production of a cylindrical part according to four steps, seen from above. To produce the cylindrical part 172, two solutions are possible, either the manufacturing nozzle 176 describes a helicoidal trajectory, or the tray 180 of the manufacturing machine turns and the manufacturing nozzle 176 rises along the manufacturing axis. The resultant trajectory from the point of view of the part is the same. However the solution with the tray 180 turning according to the arrow 178 makes it possible to simplify the control, thus this solution is preferred. In this case, the interaction according to step 168 between the manufacturing and control files makes it possible to select the manufacturing strategy simplifying the control.

In FIG. 6, the control effector 130 is in a standby position. The manufacturing nozzle 176 is in the course of depositing material. The polyarticulated control system 132 is immobile and waits while a control zone 174 passes in front of the control effector 130.

In FIG. 7, the control zone 174 passes in front of the control effector 130. The generation 114 and detection 120 lasers are activated to control the control zone 174 and emit respectively a shaped generation laser beam 134 and a shaped detection laser beam 136.

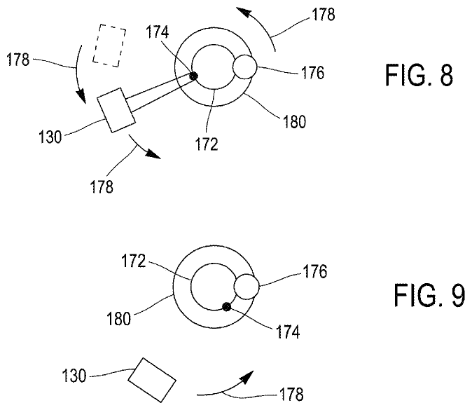

In FIG. 8, the polyarticulated control system 132 that supports the control effector 130 is displaced according to the direction of the arrow 178 to monitor the control zone 174. This movement is not programmed as such but is the consequence of the engagement of the polyarticulated control system 132 with the part 172. The polyarticulated control system 132 thus maintains the control effector 130 immobile on the control 174 of the part 172 by displacing the housing of the control effector 130 according to the direction of the arrow 178, the multichannel digital control director 112 ensures that the speed and the trajectory of the polyarticulated manufacturing system 132 make it possible to keep the control effector 130 immobile with respect to the control zone 174.

In FIG. 9, when the control of the control zone 174 has finished, the polyarticulated control system 132 disengages from the tray 180 of the manufacturing machine and the control effector 130 returns to the standby position. The zone 174 is then noted as “controlled” and the polyarticulated control system 132 awaits the passage of another zone to control. When all of the zones 174 are controlled, the polyarticulated control system 132 increments the height of the housing of the control effector 130 and carries out the control of the next stage of the part 172. The spacing between two points on a same control stage is typically of the order of several millimetres, the distance between two control stages is typically of the order of several millimetres.

In this situation, the control file comprises a table of angular values to scan and an increment in the direction of construction. The control file also comprises the duration of the control and the value of the speed of rotation of the tray 180. All the trajectories of the polyarticulated manufacturing system 138 are automatically calculated by the DCD thanks to the use of a multichannel DCD 112.

The control system and method according to the invention thus make it possible to control complex geometries of beads thanks to the dynamic adjustment of the spacing between the detection laser beam 134 and the generation laser beam 136.

The control system and method according to the invention dissociate the movement of the generation 134 and detection 136 laser beams from that of the manufacturing nozzle 176. The control may thus take place with a phase delay, which leaves time for the bead to cool and which makes it possible to avoid the control in the presence of high thermal gradients.

The control system and method according to the invention make it possible to ensure monitoring of the part in the course of its construction, its resurfacing, its repair. Thus, the control system and method according to the invention make it possible to detect defects during manufacture, to envisage a feedback loop to stop the manufacturing method or to modify certain parameters of the manufacturing method as soon as a defect is detected. The control system and method according to the invention also make it possible to control the part layer by layer.

The control system and method according to the invention make it possible to resolve the problem of managing the synchronisation of a high number of axes such as five axes for the polyarticulated manufacturing system and seven axes for the polyarticulated control system. In the prior art, the management of such a number of axes is extremely expensive in terms of computing power or even impossible. In addition, with systems of the prior art, all the axis movements must be programmed in a single programme, which makes its writing very complex.

In addition, the method and the system according to the invention make it possible to measure continuously the dynamic behaviour of the additive manufacturing machine, and notably the rate of deposition, to thus adapt the dynamic of the control effector, notably the acceleration, and synchronise the additive manufacturing machine and the control effector. Vibrations on the control effector are thus avoided.

Thus, the method according to the invention notably comprises two crucial steps. The first step consists in jointly defining the control programme and the manufacturing programme, in order to ensure controllability of the zones of interest in the course of production while guaranteeing the safety of the equipment. The second step resides in the use of a multichannel digital control director in order to ensure the synchronised management of a large number of axes, typically 12 in number: 6 axes for the polyarticulated control system 132, 5 axes for the polyarticulated manufacturing system 138 and one axis for the DADI 128. The method according to the invention thus resolves the problems of simultaneous management of a large number of axes by separating the manufacturing programme and the control programme.

The multichannel aspect of the digital control is used with an interaction and an interconnexion that do not exist in systems of the prior art.

### Bibliography

[1] CERNIGLIA D., SCAFIDI M., PANTANO A. and RUDLIN J. “Inspection of additive-manufactured layered components”, Ultrasonics, (September 2015), Vol. 62, Pages 292-298.

1-13. (canceled)

14. A controlled manufacturing system suitable for controlling a method for manufacturing, repairing or resurfacing a part, by deposition of material under concentrated energy, the controlled manufacturing system comprising:
means for obtaining a three-dimensional digital model of the part;
means for generating a manufacturing file for the part, based on the three-dimensional digital model of the part, to define manufacturing parameters of an additive manufacturing machine, the manufacturing parameters being associated with manufacturing instructions;
means for generating a control file for the part to define control parameters of a control effector, the control parameters being associated with control instructions;
analysis means for carrying out an analysis of the manufacturing file and the control file in order to determine if the manufacturing parameters and the control parameters can coexist during simultaneous application of the manufacturing parameters to the additive manufacturing machine and control parameters to the control effector; and
a control module comprising at least one communication channel for receiving and sending the manufacturing instructions to a polyarticulated manufacturing system suitable for supporting the additive manufacturing machine, and at least one communication channel for receiving and sending the control instructions to a polyarticulated control system suitable for supporting the control effector, to manage simultaneously the additive manufacturing machine and the control effector.

15. The controlled manufacturing system according to claim 14 further comprising a generation laser capable of emitting an initial generation laser beam and a detection laser capable of emitting an initial detection laser beam for carrying out a control on the part according to a laser ultrasound method.

16. The controlled manufacturing system according to claim 15, wherein the control effector comprises a device for shaping the initial generation laser beam for producing a generation laser beam and a device for shaping the initial detection laser beam for producing a detection laser beam.

17. The controlled manufacturing system according to claim 16, wherein the control effector comprises a device for adjusting an inter-laser distance to fix a distance between the generation laser beam and the detection laser beam.

18. The controlled manufacturing system according to claim 14, wherein the control module is a multichannel digital control director.

19. The controlled manufacturing system according to claim 14, wherein the control effector comprises a contactless temperature measurement probe in the vicinity of the control zone of the part.

20. The controlled manufacturing system according to claim 14, wherein the control effector is combined with one or more other control means, optionally borne by the control effector for detecting or locating defects of the part within the additive manufacturing machine.

21. A method for controlled manufacture suited for a method for manufacturing, repairing or resurfacing a part, by deposition of material under concentrated energy, comprising the steps:
generating a three-dimensional digital model of the part to manufacture, repair or resurface, for modelling the part;
generating a manufacturing file for the part, based on the three-dimensional digital model of the part, to define manufacturing parameters of an additive manufacturing machine, the manufacturing parameters being associated with manufacturing instructions;
generating a control file to define control parameters of a control device, the control parameters being associated with control instructions;
analyzying the manufacturing file with the control file in order to determine if the manufacturing parameters and the control parameters can coexist during simultaneous application of the manufacturing parameters to the additive manufacturing machine and the control parameters to the control effector; and
if the manufacturing parameters and the control parameters can coexist, simultaneous managing the additive manufacturing machine and the control effector for manufacturing, repairing or resurfacing the part, the simultaneous management being based on the manufacturing instructions and the control instructions.

22. The method for controlled manufacture according to claim 21 further comprising the step, if the manufacturing parameters and the control parameters cannot coexist:
generating a manufacturing file for the part, based on the three-dimensional digital model of the part, to define manufacturing parameters of an additive manufacturing machine, the manufacturing parameters being associated with manufacturing instructions; and/or
generating a control file to define control parameters of the control effector, the control parameters being associated with control instructions.

23. The method for controlled manufacture according to claim 21, wherein the method for manufacturing, repairing or resurfacing the part by deposition of material under concentrated energy is a method for melting metal powder by laser, melting metal wire by laser or melting metal wire by electric arc.

24. The method for controlled manufacture according to claim 21, wherein the control instructions target regions of the part having increased probabilities of appearance of defects.

25. The method for controlled manufacture according to claim 21, wherein a detection of defects leads to stoppage of manufacture.

26. The method for controlled manufacture according to claim 21, wherein a detection of defects leads to carrying out of a corrective action, the corrective action being melting or machining of a defective zone of the part.
